(19) United States
(12) Patent Application Publication
(10) Pub. No.: US 2008/0074813 A1
(43) Pub. Date: Mar. 27, 2008

(54) Discharge protection circuit

(76) Inventors: Aviad Wertheimer, Zur-Hadassah (IL); Rushdy Saba, Haifa (IL)

Correspondence Address: INTEL CORPORATION;c/o INTELLEVATE, LLC, P.O. BOX 52050, MINNEAPOLIS, MN, 55402, US

(21) Appl. No.: 11/527,923

(22) Filed: Sep. 26, 2006

(51) Int. Cl. H02H 9/00

(52) U.S. Cl. 361/56

(57) ABSTRACT

In some embodiments, a discharge protection circuit having an operational mode and a protection mode is provided.

### BACKGROUND

Electrostatic discharge (ESD) events can damage integrated circuits (ICs) through their connector interfaces. A cable discharge event (CDE) is an ESD event that happens when a cable is connected to a device (or while it is connected to a device) that is statically charged to a different potential. When this happens, charge transfers, either into or out of the integrated circuit, until equilibrium is reached. Cable or device charging can result from triboelectric charging (friction), e.g., when a cable is dragged along the floor. Tribocharges are created at the surface of the cable, attracting negative charges inside the cable, which can cause arcing when the cable is connected. Many cables today have very low leakage and thus can retain charge for extended periods of time, thereby increasing the chance of CDE occurrence. A cable could also become charged by induced voltages, for example, when a cable is subjected to a strong pulse from a nearby wire such as from ESD close to the cable or from a lightning strike.

CDE events can be particularly problematic because a CDE waveform can have high energy and exhibit both voltage and current drive. Moreover, they can exhibit rapid polarity reversals and have long durations, e.g., in excess of hundreds of nanoseconds. In fact, some CDE waveforms have actually been measured in seconds of time.

With reference to FIG. 1A, traditional ESD solutions have involved the use of a clamping circuit such as power clamp circuit 102. Clamp circuit 102 is coupled to protected circuit 101 to suppress positive voltage spikes at node A. Clamp circuit 102 is a unidirectional, active voltage clamping circuit designed to turn on when a sufficient voltage surge occurs at its terminals and then turn back off, e.g., after a period of time sufficient for the surge to have been discharged. FIGS. 1B and 1C show examples of clamp circuits 102.

The clamp circuit of FIG. 1B comprises a PMOS transistor P, resistor R, and capacitor C, coupled together as indicated. The resistor and capacitor function as a timer to turn on the transistor when the voltage at its positive terminal sufficiently increases (in excess of the transistor's threshold voltage) relative to the voltage at its negative terminal in a sufficiently short amount of time. When this happens, a negative pulse applies across its gate/source. This turns it on for a duration corresponding to the magnitude and duration of the voltage spike and the magnitude of the RC time constant associated with the resistor and capacitor. The clamp circuit of FIG. 1C operates in the same way, except that it employs an NMOS transistor and thus reverses the positions of the resistor and capacitor. Unfortunately, clamp circuit 102 doesn't work for negative voltage surges. In addition, it may also not work well when Nodes A, B are to conduct high-frequency signals because as the impedance of C increases (with increased signal frequency), the signal may be more apt to turn on the transistor resulting in energy from the signal being leached away by the clamp.

(The term “PMOS transistor” refers to a P-type metal oxide semiconductor field effect transistor. Likewise, “NMOS transistor” refers to an N-type metal oxide semiconductor field effect transistor. It should be appreciated that whenever the terms: “transistor”, “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs and oxide thicknesses to mention just a few. Moreover, unless specifically referred to as MOS or the like, the term transistor can include other suitable transistor types, e.g., junction-field-effect transistors, bipolar-junction transistors, and various types of three dimensional transistors, known today or not yet developed.)

With reference to FIG. 2, other approaches have involved the use of transient-voltage-suppression (TVS) diodes (Z1, Z2) coupled together as shown between nodes A and B. Similar to zener diodes, TVS diodes are designed to rapidly clamp at a specific voltage, and they also typically have low capacitance. Thus, coupled together as indicated, they can suppress both positive and negative spikes and with their small capacitances, can work effectively for high-frequency applications. Unfortunately, they can be expensive and difficult to implement, especially in some integrated circuit processes.

Accordingly, improved ESD solutions are desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A is a schematic diagram of a circuit with conventional ESD protection.

FIG. 1B is a schematic diagram of a conventional power clamp that may be used in the circuit of FIG. 1A.

FIG. 1C is a schematic diagram of another conventional power clamp that may be used in the circuit of FIG. 1A.

FIG. 2 is a schematic diagram of a conventional ESD protection circuit using TVS diodes.

FIG. 3 is a schematic diagram of an ESD circuit in accordance with some embodiments.

FIG. 4 is a schematic diagram of another ESD protection circuit in accordance with some embodiments.

FIG. 5 is a diagram of the ESD protection circuit of FIG. 4 implemented to protect link interfacing circuitry at a connector interface in accordance with some embodiments.

FIG. 6 is a block diagram of a computer system with a link interface chip having ESD protection circuitry in accordance with some embodiments.

### DETAILED DESCRIPTION

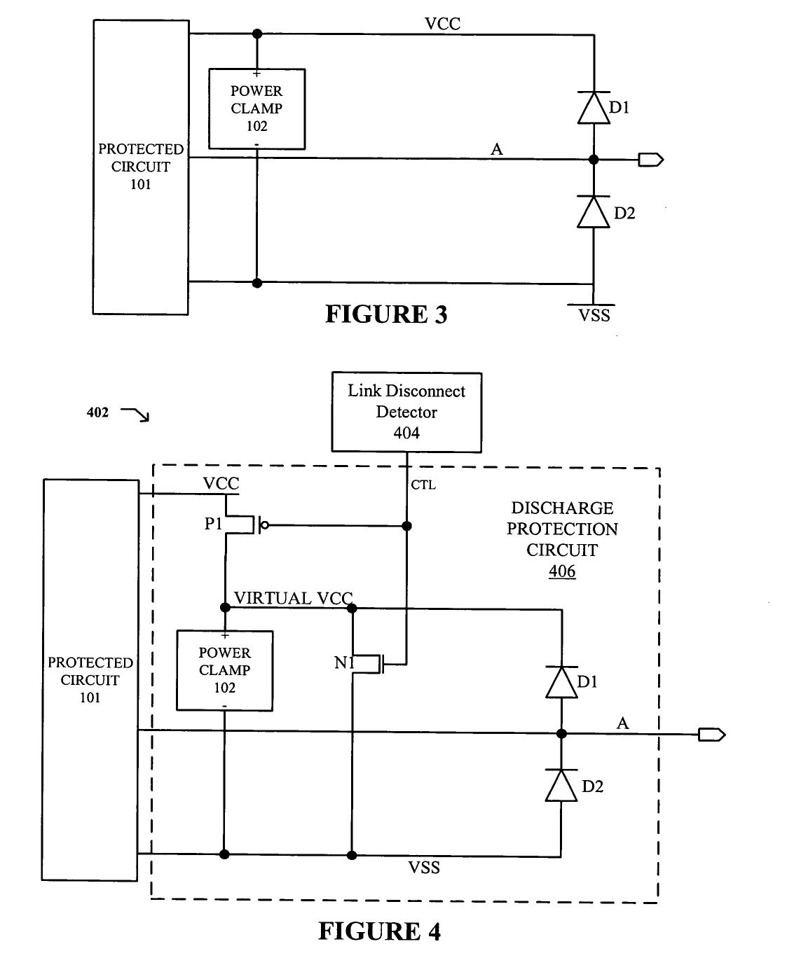

With reference to FIG. 3, an ESD protection circuit, in accordance with some embodiments, capable of suppressing both positive and negative voltage surges, is shown. It comprises a conventional power clamp 102 and rectifiers D1 and D2, coupled together as indicated to suppress voltage spikes at node A. Power clamp 102 is coupled between VCC and VSS to clamp voltage spikes at node A. Rectifiers D1, D2 are coupled between node A and VCC and VSS, respectively, to unidirectionally block the supply references (VCC, VSS) from node A. In this way, a signal operating window ranging from between VSS−V_{D} to VCC+V_{D} is created allowing a signal to be carried at node A without the power clamp turning on and leaching away energy from the signal. (V_{D} is the forward bias voltage drop across D1 or D2, e.g., about 0.6 V.)

Thus, in operation, when the circuit is powered on, surges spiking outside of this window are clamped. When the circuit is powered off, the signal operating window collapses, and the power clamp turns on even faster suppressing surges that only have to exceed VSS+/−V_{D}, thereby providing even better protection for circuit 101. Unfortunately, CDE events commonly happen when a cable (e.g., an Ethernet cable) is connected to a device while the circuit 101 is powered on. for this case, the clamp will only protect against CDE events spiking outside of the signal operating window. In some environments, this may not be adequate. Accordingly, another circuit solution addressing this problem is discussed in the following section.

FIG. 4 shows an ESD circuit 402 to protect circuit 101 at a signal node A, in accordance with other embodiments. The ESD circuit 402 comprises a link disconnect detector circuit 404 coupled to a discharge protection circuit 406. The discharge protection circuit 406 comprises power clamp 102 and rectifiers D1, D2, coupled together as described with respect to FIG. 3 (except that the power clamp 102 is coupled to a controllable VIRTUAL VCC node rather than to VCC). In addition, however, it also comprises transistors P1 and N1, coupled as indicated to VCC, the VIRTUAL VCC node, VSS and node A to discharge the power clamp 102 and couple its high side to VSS during a disconnect mode, e.g., when a link partner is not actively coupled to circuit 101.

The link disconnect detector 404 comprises circuitry to determine if a link partner is actively connected and to turn on P1 and turn off N1 if so connected and turn on N1 and turn off P1 when not actively connected. For example, with some interface protocols (e.g., Ethernet media dependant interface), when a link partner (e.g., a router, network interface, etc.) is coupled at the other end of a connected cable, it may transmit one or more signals to identify itself and/or indicate that it is “online”. With such an interface, the detector 404 could comprise appropriate timer and signal detect circuitry, as would be known to a person of ordinary skill, to identify such signaling and determine that the link partner is online. Thus, if a cable is not connected to circuit 101 or if it is connected but does not have an active link partner at its other end, the link detector 404 will control P1 and N1 to be in a protected mode, keeping the high side of clamp 102 coupled to VSS and thus clamping node A to VSS+/−V_{D}. On the other hand, if a link partner is online, it controls P1 to be on and N1 to be off, thereby allowing circuit 101 to operate with node A able to conduct signals in the signal operating window without the clamp turning on. An advantage of this detection scheme is that it maintains the ESD circuit 402 in the protected mode when no active link partner is online, even when a cable is connected and circuit 101 is powered up. It also ensures that whenever a cable is being connected, the discharge circuit 406 will be in the protected mode with the clamp discharged, thereby clamping any discharge voltages exceeding the diode turn-on levels.

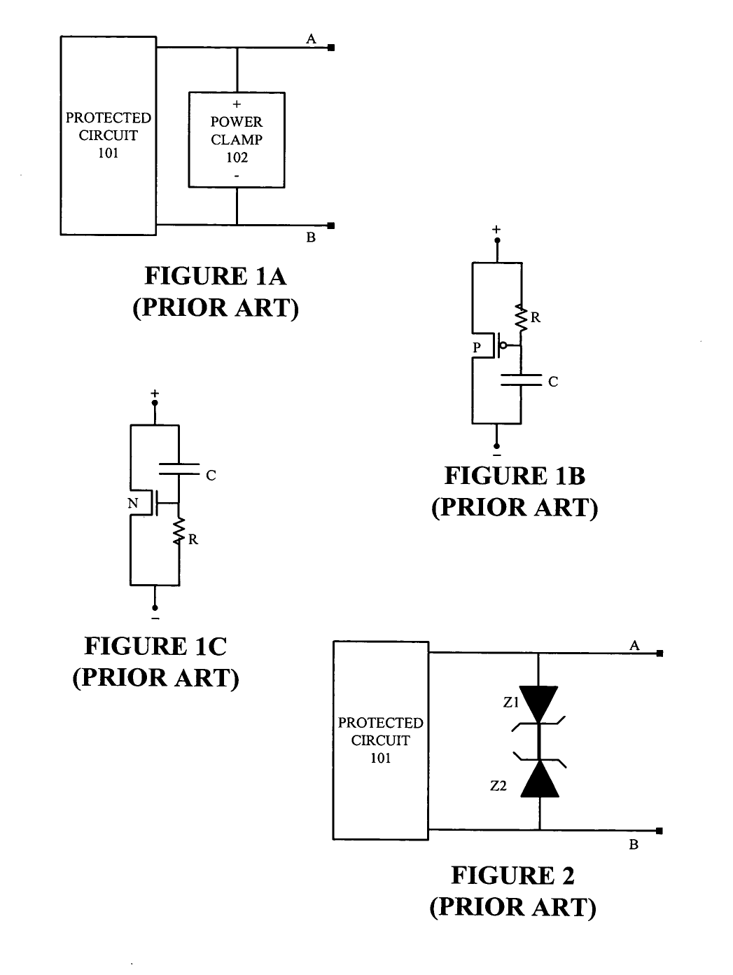

It should be appreciated that discharge circuit 406 may have other configurations and still be effective to provide adequate ESD protection. Moreover, other circuit elements or coupling arrangements could be used. For example, while conventional power clamp 102 is employed, there are many types of power clamp circuits, including those that are currently available and others not yet developed, that could be used in addition to the active clamp circuits discussed with reference to FIG. 1. Furthermore, it should be appreciated that rectifiers D1 and D2 could be implemented with any suitable rectifier such as a diode formed from a PN junction, a transistor, or from another rectifying structure. In addition, a circuit other than a link disconnect detector could be used to detect other types of situations when circuit 101 could be vulnerable to an ESD event. For example, it could merely detect if a cable is connected (e.g., through a switch in a connector or through a continuity confirmation when a connector is connected. Other schemes for determining when a protected mode should be entered could be used as well.

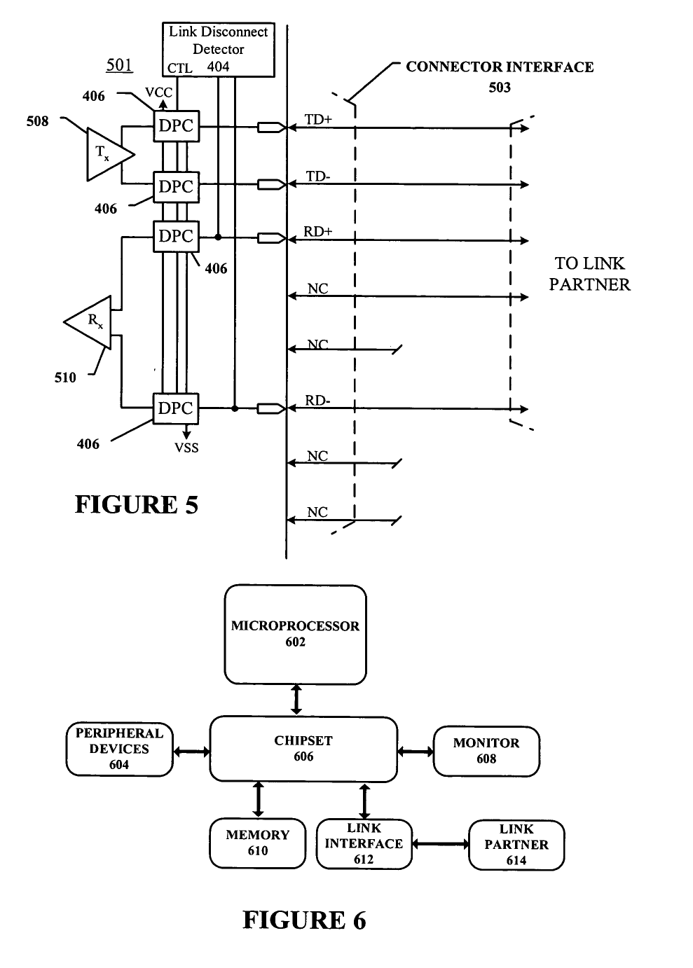

FIG. 5 shows a schematic of an exemplary connector interface (Ethernet 10BaseT) 503 on a chip 501 having discharge protection circuitry as discussed above. It comprises four discharge protection circuits 406 coupled to a link disconnect detector 404, VSS, VCC and differential signal nodes (TD+, TD−, RD+, RD−) to protect circuitry on a chip 501 (such as a PHY interface chip) including a transmitter 508 and receiver 510, which are coupled to the signal nodes as shown. A separate discharge circuit 406 is coupled to each signal node to clamp the node relative to a VSS on the chip. The link disconnect detector 404 is coupled to differential receiver nodes RD+, RD− to detect when a link partner is actively coupled to the connector's cable. When it detects an actively connected link partner, it controls each protection circuit 406 to turn on its P1 transistor and turn off its N1 transistor in order to provide the signal operating window for the signal nodes. Conversely, when a link partner is not detected, detector 404 turns off the P1 transistors and turns on the N1 transistors to discharge the power clamps and limit voltage spikes at the signal nodes. It should be appreciated that this protection configuration could be used for any type of connector interface. for example, it could be used for common mode nodes, as well as for differential nodes.

With reference to FIG. 6, one example of a computer system is shown. The depicted system generally comprises a processor 602 coupled to a chipset 606, which is coupled to peripheral devices 604, memory 610, a monitor 608, and a link interface chip 612 (PHY chip), in turn coupled to a link partner 614 such as a router for connection to a network. The chipset 606 may actually comprise one or more chips, or be implemented, wholly or partially, within processor 602. The link interface chip 612 has a connector interface with at least one ESD protection circuit as disclosed herein to protect interface chip 612 from an ESD event such as a cable discharge event when a cable coupling link partner 614 is connected to the interface chip 612.

The depicted system could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a signal node, a high supply referenced node, and a low supply reference node;
a power clamp coupled between the high and low supply reference nodes; and
a first rectifier coupled between the signal node and the high supply reference node and a second rectifier coupled between the signal node and the low supply reference node, said first and second rectifiers to unidirectionally block the supply reference nodes from the signal node to provide a signal operating window.

2. The chip of claim 1, in which the high supply reference is a virtual high supply reference node, the chip comprising a transistor coupled between a voltage supply and said virtual high supply reference node to controllably provide a high supply voltage at the virtual high supply reference node when a link partner is actively coupled to the signal node.

3. The chip of claim 2, in which the transistor is a PMOS transistor.

4. The chip of claim 2, comprising a second transistor coupled between the virtual high supply reference node and the low supply reference node to discharge the virtual high supply reference node during a protected mode.

5. The chip of claim 4, in which the second transistor comprises an NMOS transistor.

6. The chip of claim 4, in which the protected mode is entered when a link partner is not actively coupled to the signal node.

7. The chip of claim 1, in which the power clamp comprises a transistor controllably coupled to

8. The chip of claim 7, in which the power clamp comprises a timer circuit formed from a resistor and a capacitor coupled between the high and low supply reference nodes.

9. An integrated circuit, comprising:
a signal node to be coupled to an external link partner; and
a discharge protection circuit coupled to the signal node to provide it with a signal operating window when the link partner is actively coupled to the signal node.

10. The integrated circuit of claim 9, comprising a link detection circuit coupled to the discharge protection circuit to control it to provide the signal operating window when detecting the link partner actively coupled to the signal node.

11. The integrated circuit of claim 9, in which the discharge protection circuit comprises a power clamp coupled between a virtual high supply reference node and a low supply reference node.

12. The integrated circuit of claim 11, in which the discharge protection circuit comprises a transistor coupled between a voltage supply and said virtual high supply reference node to controllably provide a high supply voltage at the virtual high supply reference node when the link partner is actively coupled to the signal node.

13. The integrated circuit of claim 12, in which the transistor is a PMOS transistor.

14. The integrated circuit of claim 12, comprising a second transistor coupled between the virtual high supply reference node and the low supply reference node to discharge the virtual high supply reference node during a protected mode.

15. The integrated circuit of claim 14, in which the second transistor comprises an NMOS

16. The integrated circuit of claim 14, in which the protected mode is entered when a link partner is not actively coupled to the signal node.

17. The integrated circuit of claim 11, in which the power clamp comprises a transistor controllably coupled to a timer circuit coupled between the virtual high and low supply reference nodes.

18. A system, comprising:
(a) a microprocessor chip;
(b) at least one memory chip coupled to the microprocessor chip; and
(c) a link interface chip to coupled a link partner to the microprocessor chip, the link interface chip comprising a signal node to be coupled to the link partner, and a discharge protection circuit coupled to the signal node to provide it with a signal operating window when the link partner is actively coupled to the signal node.

19. The system of claim 18, in which the link interface chip comprises a link detection circuit coupled to the discharge protection circuit to control it to provide the signal operating window when detecting the link partner actively coupled to the signal node.

20. A chip comprising:
a detection circuit to detect a cable connection; and
a discharge protection circuit coupled to the detection circuit, the discharge protection circuit to be in a protection mode while the cable is being connected and for a duration after it has been connected.

21. The chip of claim 19, in which the detection circuit causes the discharge protection circuit to be substantially discharged during the protected mode.
